(19) United States
(12) Patent Application Publication
(10) Pub. No.: US 2009/0188407 A1
(43) Pub. Date: Jul. 30, 2009

(54) Method for treating surfaces

(76) Inventor: Saila Karvinen, Helsinki (FI)

Correspondence Address: BIRCH STEWART KOLASCH & BIRCH, PO BOX 747, FALLS CHURCH, VA, 22040-0747, US

(21) Appl. No.: 10/585,330

(22) PCT Filed: Jan. 5, 2005
(86) PCT No.: PCT/FI2005/000008

§ 371 Date: Jul. 6, 2006

(30) Foreign Application Priority Data
Jan. 7, 2004 (FI) 20040011

(51) Int. Cl. C09D 1/00

(52) U.S. Cl. 106/286.3; 106/286.4

(57) ABSTRACT

The present invention relates to a method for treating surfaces with a composition comprising nanocrystalline titanium dioxide. The composition can be used in powder form or as a thixotropic aqueous solution. After physical removal, such as rinsing or wiping, the composition remains on the surface, forming a photocatalytic and/or dirt repellent layer on top of the treated surface.

The present invention relates to a method according to the preamble of Claim 1 for treating surfaces with titanium dioxide.

The invention further relates to the use according to Claim 10.

Normally, the windows of both private apartments and public buildings in cities, in particular, require washing several times a year. The windows of a car may even require thorough daily washing, if the amount of dust flying in the air is considerable, e.g., during pollination or in the autumn under slushy road conditions.

Correspondingly, various ceramic or glass ceramic surfaces, such as the tiles in bathrooms or kitchens, enamelled surfaces or metal surfaces, such as the surfaces of stoves, the inner surfaces of ovens, or washbasins and toilet bowls are surfaces, which should be cleaned fairly often, even on a daily basis or several times a day. Similarly, painted or lacquered surfaces, such as the surfaces and doors of kitchen cupboards or bathroom cabinets, painted walls in kitchens and bathrooms, or the painted surfaces of cars, etc. need fairly frequent cleaning.

Typically, surfactants are employed in washing, and the detergent compositions also contain solvents, such as lower alcohols, isopropanol in particular. Typically, the surfactants are so-called double-ended, wherein one end is hydrophilic and the other one lyophilic, or the one end is charged and the other end uncharged. Amphoteric surface-active agents are also known, changing the charging of the molecule as a function of pH.

These surface-active agents typically surround a dirt particle, detaching it then from its base. The dirt particles, in turn, are attached to their bases by means of an electric charge, and extremely tiny particles also by so-called van der Waal's forces (“forces of attraction”). Small particles obtain their charge from several sources; generally, it is generated triboelectrically, i.e., by means of friction. In addition, there is so-called greasy dirt provided, wherein greasy or oily molecules are condensed from the air onto the surfaces, collecting more and more similar ingredients from the air onto the surface. A proper detergent both dissolves the said grease and envelops the dirt particles with a layer that brings it to the washing water in a hydrophilic form.

The surfactants can be synthetic or vegetable-based. Generally, vegetable-based surfactants are quicker to decompose in waste waters than synthetic surfactants. Regarding the solvent substances, water-soluble glycols and alcohols, such as isopropanol, propylene glycol and glycerol are compounds that decompose rapidly in nature. Instead, aromatic and chlorinated hydrocarbons are poorly degradable and harmful solvents. They are mainly found in special cleaning agents. Some general-purpose detergents include aliphatic hydrocarbons as solvents. They are easier to biodegrade than aromatic hydrocarbons, although not harmless.

Abundant use of detergents is expensive and detrimental to the environment. Continuous washing and cleaning also takes a lot of time.

Hence, it would be desirable to provide a solution for cleaning and treating various glass surfaces, such as the windows of buildings and cars, and various ceramic surfaces, such as tiles or similar surfaces that get dirty, so that they stay clean as long as possible, decreasing the need for using detergents and the time used for washing.

Any surface, which is to be dirt-resistant, should be of such a nature that grease and oil or hydrocarbons, in general, will not condense on it and that any dirt particles are uncharged before they stick to the surface. One known way to solve the problem is to form, on the surface, a layer which either has no charges or which removes electrical charges. Accordingly, U.S. Pat. No. 5,723,172 discloses how a protective coating is formed on the surface of glass by condensing onto it silanes and organic gas, such as butane, to make the glass dirt- and scratch-resistant. U.S. Pat. No. 5,789,036 describes how the surface of a glass pane is rendered dirt-resistant by treating it with a water insoluble surface-active agent, such as sulphodioctyl ester and fluoroalkyl carboxylate, which are applied onto the surface by means of a solvent. U.S. Pat. No. 5,759,618 describes how the surface of glass is rendered water- and dirt-repellent by first treating it with an acid solution containing hydrofluoric acid, sulphuric acid and phosphoric acid, and after this treating the surface with alkyl alkoxy silanes.

In literature, other articles and patents that deal with glass surfaces treated with silane and/or fluorine compounds can be found, and the main purpose of these known solutions is to decrease the wetting of surfaces with water, whereby they are more dirt-resistant, when raining, for example.

In the known compositions, mostly, the polymer is dissolved in hydrocarbon or alcohol, such as heptane or isopropanol, which is why the treatment must be carried out in a well-ventilated space. Furthermore, any polymers containing siliceous and/or fluorine-containing polymers are substances foreign to nature, not being water-soluble and not degrading easily in nature.

It is also well-known to use various nanoparticles in detergents and cleaning agents. Published Patent Application WO 01/32820 A1 suggests tenside-based detergents and cleaning agents be spread onto the surfaces, containing metal oxides and sols of 5 to 500 nm, in an amount of 0.01 to 35% by weight. According to the publication, suitable particles include, for example, silicon gels, Mg(OH)₂, ZrO₂, ZnO, TiO₂, TiN, Al₂O₃ sol, TiO₂ sol. In addition to the particles mentioned above, the detergents and cleaning agents according to the publication contained from 0.1 to 50% by weight of tensides and, for example, complexing agents, agents increasing hydrophilicity, such as water-soluble polyvalent alcohols, alkanol amine or glycol ether, organic solvents that can be mixed with water, and various polymers as thickening agents. The publication does not mention any effects of the various particles or tensides on the surface.

Published Patent Application DE 102 01 596 A1, in turn, describes a cleaning agent containing aqueous or alcoholic dispersions of nanoparticles, such as SiO₂, TiO₂, ZrO₂, SnO₂, CeO₂, AlOOH or mixed oxides in an amount of 0.1 to 10% by weight. The nanoparticles are stabilized with silane, tensides, and betaine or, in the case of titanium dioxide, with ethanolamine, diethanolamine in particular. The publication describes the preparation of a compound containing titanium dioxide, isopropanol and sodium dodecyl sulphate and that of a titanium ethanolamine complex. The compounds were filtered by filters of 1 μm. The cleaning agent composition was suggested to be used for washing hard surfaces, such as glass surfaces.

Published Patent Application WO 96/23051 suggests that windows be washed with anatase having a particle size of less than 100 nm and a specific surface of more than 150 m²/g. The publication proposes the use of titanium dioxide in concentrations of 0.1 to 5% by weight. The composition according to the example contained isopropanol, water, a dispergent and 3% of a TiO₂ dispersion of 15% by weight. The composition was suggested to be used for killing off bacteria and for photo oxidation in a detergent and also in laundering, as well as in maintaining any surfaces exposed to light. However, apparently no titanium dioxide layers had remained on the surfaces after cleaning.

Hocken et al. (2003) have discussed the possibility of using titanium dioxide sols in self-cleaning surfaces. In these sols, the size of titanium dioxide particles would be from 1 to 1000 nm. The publication also describes a silicate-based composition containing, per 100 g of composition, 30.32 g of titanium dioxide, 44.58 g of water, and the binding agents used were 15.01 g of Betolin P35 (potassium silicate) and 6.67 g of Acronal 290 D (acrylate).

Patent Specification U.S. Pat. No. 2,428,317 suggests the use of water-dispersible titanium dioxide TiO₂ in detergents and cleaning agents in addition to ground silica SiO₂ and powdered soap. The amount of water-dispersible titanium dioxide in detergents and cleaning agents was from 10 to 20% by weight. The titanium oxide in the cleaning agent functioned increasing the foam, absorbing oil and grease, and decreasing the abrasive effect of silica, and it was washed off from the surface being cleaned so that no pigment layer remained on the surface. As TiO₂ had been screened with a 300-mesh screen, it is likely that the major part of the particles consisted of pigmentary titanium dioxide (with a crystal size of about 220 nm) having its absorption maximum in the area of visible light. Titanium dioxide (from 0.1 to 2.0% by weight) has also been suggested to be used in cosmetic and cleansing dental lacquers in published Patent Application DE 197 22 596 A1.

Published Patent Application EP 0 314 050 A2 discloses a thixotropic aqueous automatic dishwashing detergent composition of a gel type, having 0.5 to 5% by weight of alumina or titanium oxide added into to prevent film-forming in connection with washing.

Published Patent Application WO 99/51345 describes a photocatalytic composition, wherein a photocatalyst agent is coated with colloidal silica dioxide dispersion, wherein the silica particles are capable of being bound to one another and to the surface.

The publication Journal of Chemical Education 75(6):750-751 (June 1998) examined the photocatalytic dispersion of gaseous organic contaminants by means of anatase. A TiO₂ powder was dissolved in a solution of ethanol and water (3:7 v/v), whereby a 5% by weight TiO₂ mixture was obtained. Efforts were made to form a coating on a microscope glass by means of such a solution by immersing the glass into the solution and drying it. The phases were repeated several times in turns. Finally, to stabilize the coating, the glasses were kept in an oven at 110° C. overnight.

Publication WO 03/048048 describes the preparation and use of a titanium dioxide photocatalyst. Titanium dioxide powder and silica sol (Snow tex-N of Nissan Chemicals) were mixed and ground by hand to prepare coating slurry. The slurry was used to coat a sheet of fibreglass using the capability of SiO₂ to bind itself to the surface of the sheet. TiO₂ was used in the test to measure the photocatalytic activity.

Efforts have been made to achieve long-term protection of surfaces by developing self-cleaning surfaces, such as glass panes, mirrors, eyeglasses, walls etc. The self-cleanliness of the surfaces is based on the fact that the surface being protected is provided with a special coating of titanium dioxide, which on the surfaces functions as a photoactive agent in the UV region. When exposed to sunlight, the coating reacts in two ways. First, it breaks up organic dirt and, next, rain water will spread onto the surface, forming a film and rinsing off the detached dirt. The photocatalytic process of the coating is started by the ultraviolet radiation of the sun. One significant advantage in using titanium dioxide is its hydrophilicity. On the market, there are self-cleaning glasses based on titanium dioxide, for example, under the trade names of Pilkington Activ™ and Sun Clean®, Self-Cleaning Glass by PPG. The use of titanium oxide and also other oxides, such as ZnO, SnO₂, SrTiO₃, WO₃, Bi₂O₃ and FeO in protecting the surfaces is described in published Patent Applications EP 0816466 A1 and EP 0869156 A1. In the protection, the crystalline form of titanium dioxide, anatase, in particular, is used in the form of a sol. The surface being protected is coated with amorphous titanium by hydrolysis and dehydration polycondensation of an organotitanium compound, e.g., tetraethoxytitanium. After this, the surface is fired at 400-600° C. to transform the amorphous titanium into crystalline titanium dioxide (anatase).

The Activ™ titanium dioxide layer is prepared by the APCVD method onto the surface of a hot glass (typically 615° C.) from steam that mainly contains nitrogen as a carrier gas and the following reactive agents: titanium tetrachloride (with a boiling temperature of 35° C.) and, as a source of oxygen, ethyl acetate (with a boiling temperature of 35° C.). In the APCVD method, the use of a titanium oxide film is advantageous, as it is especially suitable when manufacturing large amounts of coated glass. Typically, the final thickness of the titanium oxide film is about 15 nm. The total thickness of the silicon oxide/titanium oxide surface on top of a 4 mm glass is about 45 nm. Under the TiO₂ coating, there is a SiO₂ coating so that the Na of the glass will not destroy the photoactivity of the TiO₂ at the high temperature of 615° C.

The TiO₂ surfaces can also be prepared, for example, by the sol-gel technology (Shirthikeyan, 1995), by chemical vapour deposition (Ha et al. 1997), by dc reactive magnetron sputtering, RF reaction magnetron sputtering, mid-frequency magnetron sputtering) (Perry et al. 1997 and Sugail et al. 1992), by electrochemical deposition (Jang et al. 2001) or by the plasma spray coating method (Zhu et al. 1998).

Coating of a glass ceramic surface, such as an oven, with TiO₂ has also been suggested in the published Patent Application EO 1 142 842 A1.

The purpose of the present invention is to eliminate at least some of the disadvantages of prior art and to provide quite a new kind of a solution for decreasing the contamination of glass panes, tiles and other similar objects.

The invention is based on the surprising observation that the adhesion of nanocrystalline titanium dioxide to various surfaces, such as glass or ceramic surfaces, metal surfaces or cloth is so high that even after a physical treatment, such as rinsing, wiping or vacuum-cleaning, a thin protective layer of titanium dioxide remains on the surface.

The invention can be implemented so that the selected surface is treated with a composition that comprises nanocrystalline titanium dioxide. The composition is spread onto the surface by means of water, or the composition already contains enough water to make the spreading onto the surface successful. After this, any excess nanocrystalline titanium dioxide is removed from the surface by some suitable physical method, as necessary. The remaining nanocrystalline titanium dioxide forms a photocatalytic and/or dirt-repellent layer on the surface.

The titanium dioxide can be spread as powder onto the surface by means of a suitable instrument and water, or a mixture is preferably formed from the titanium dioxide and water, being stiffer than an aqueous dispersion; paint-like.

The composition preferably comprises titanium dioxide in such a compound of nanocrystals and agglomerates that an essential part of the particles in the aqueous solution will sediment.

The composition forms a protective hydrophilic dirt-resistant layer on the surface. Upon activating by the effect of light, the composition functions as a photocatalyst, cleaning the air.

To be more precise, the method according to the invention is characterized by what is stated in the characterizing part of Claim 1.

The use according to the invention, in turn, is characterized in by what is stated in the characterizing part of Claim 10.

The invention provides considerable advantages. Although forming a layer of titanium dioxide on the surface being cleaned is very simple, the surfaces can be rendered extremely hydrophilic and photocatalytic. We have discovered that after the treatment, the surface remains self-cleaning for 2 to 8 weeks and even in conditions of heavy contamination, from 2 to 4 weeks.

The invention can similarly be used to effectively decrease the contamination of the surface of a base, which is exposed to outdoor air or some other type of contaminating environment, by more than a half. The composition used is aqueous and does not contain dangerous chemicals or agents foreign to the environment.

In winter, the rear window of a car that is treated with the composition according to the invention melts quicker than an untreated rear window. The treated car remains cleaner and the number of washings can be reduced. Kitchens, washrooms and other spaces remain cleaner and the number of washings can be reduced by about a half. Being slippery, odourless, dust-free, and harmless to health and the environment, the composition according to the invention is pleasant to use.

Eyeglasses remain clear, when the temperature quickly changes, such as when entering a sauna or when going indoors, where it is warm, from out of doors in winter.

As one of the advantageous properties of titanium dioxide is its capability to clean the air, a layer that cleans the air is provided in the room, when treating large surfaces, such as walls or ceilings. This is based on the fact that titanium dioxide breaks up any organic impurities in the air by means of light. Light excites the electron of the titanium dioxide onto a higher energy level and, at the same time, an electron hole is formed, which can participate in the oxidation reactions with the environment.

The invention can also be used in treating noise barriers, for example. In that case, they stay clean for a longer period of time and, additionally, they also clean the air.

As titanium dioxide is known to break up carcinogens, such as formaldehyde and volatile organic compounds (VOC), to remove odours and freshen the air, the use of the composition in treating various indoor surfaces, such as walls and ceilings, is advantageous. Furthermore, titanium dioxide is known to destroy the causes of diseases in the presence of light; therefore, it is advantageous to use the composition in kitchens and bathrooms in particular. It is also advantageous to use the composition in spaces, where food stuffs are kept and where it is necessary to remove harmful odours or micro organisms, provided that lighting can be used in the spaces in question. The composition can either be applied on the walls and the ceiling of a storehouse or on containers or their covers or caps.

The composition can also be used in treating the filter foils of air filters, or filter cloths.

Another advantage of the invention is that the method according to the invention can be used at low temperatures, such as room temperature, or outdoors at temperatures of over 0° C. and at normal pressure. Furthermore, using the method according to the invention is very simple. In the titanium dioxide coating methods according to prior art, for example, ALE (Atomic layer epitaxy), TiO₂ coatings of certain thicknesses are obtained, but the temperature then is 500° C. In the present method, the TiO₂ particles are made at a suitable temperature before coating and the coating can be made at a desired temperature. A coating made using the method according to the invention is good in withstanding temperatures that vary on both sides of the freezing point of water, as much as from −30° C. to at least +30° C.

Compared with compositions according to the known technology, the compositions according to the preferred embodiments of the present invention are usable as powders or paint-like aqueous solutions of a thixotropic stiffness. In the present compositions, there is no need to prepare dispersions or sols from the titanium dioxide. In preparing the composition, titanium dioxide particles are preferably used the essential part of which sediments in the aqueous solution. In the preferred embodiments of the present invention, the crystal size of the titanium dioxide is from 3 to 200 nm. An essential part of these, i.e., over 50% forms agglomerates in advantageous compositions. The size of the agglomerates is preferably over 1 micrometer but less than 30 micrometers, preferably from 5 to 15 micrometers. The occurrence of the agglomerates has the benefit that the titanium dioxide powder then exhibits less dust formation. A surprising fact in the invention, in particular, is that, even as powder, the titanium dioxide does not scratch the treated surfaces.

The compositions according to prior art include nanoparticles, from which aqueous dispersions or sols are formed. In the present invention, it has been observed that dispersions and sols do not function as well as thicker compositions, and they are also more difficult to use. In addition, keeping the titanium dioxide as dispersions generally requires the use of additives.

In the present invention, the nanoparticles do not need to be coated, which brings about the benefit that the particles then function as photocatalysts as effectively as possible. Neither is there a need to form complexes from the nanoparticles in the compositions of the present invention. No high temperatures are needed in the preparation of the composition, and the preparation is not multi-stage. No organic or inorganic binding agents or solvents, or additives to dispersion are necessarily needed in the composition. Tensides are not necessarily needed in the composition, nor are alcohols, although there is no harm in using them in the composition, on the other hand.

The present method can be used for treating surfaces several times or patching areas, which have been treated but remain uneven. The present method can also be used to treat TiO₂ coatings that have been made according to prior art but have damaged.

According to a general concept, detergents should be alkaline to detach greasy dirt in particular. However, in connection with this invention, it was surprisingly observed that when applied by means of water or as an aqueous paint-like solution, titanium dioxide is very good in detaching greasy dirt.

In the following, the invention is described more closely with the aid of a detailed description and application examples.

According to the present invention, various surfaces are treated with nanocrystalline titanium dioxide by means of water.

The invention is preferably implemented so that a composition comprising nanocrystalline titanium dioxide is spread by means of a suitable medium and water onto the surface being treated in such a concentration that the layer remaining on the surface appears clearly white. After this, as necessary, any excess titanium dioxide is removed from the surface by some physical removal method, such as rinsing with water, wiping or vacuuming, until the white colour caused by the titanium dioxide is removed from the surface. In this way, a very thin, transparent layer of titanium dioxide remains on the surface, protecting the cleaned surface and/or functioning photocatalytically.

In connection with the invention, physical removal means wiping with a cloth, sponge or similar auxiliary means, rinsing or spraying with water, vacuuming, shaking or airing. The physical removal should not be too vigorous and no sharp objects or excessive abrasion are allowed.

The nanocrystalline titanium dioxide may be either one of the crystalline forms of titanium dioxide, anatase or rutile, or various compounds of these and amorphous titanium dioxide. Adsorbing water and hydroxyl groups on its surface better than rutile, anatase is the most advantageous. On the other hand, in visible light, rutile functions better than anatase due to the energy difference between its crystalline structures and a so-called forbidden gap. The energy of the forbidden gap tells the minimum energy, which the light must have in order to activate electrons for movement, and this energy is smaller for rutile than for anatase. In a photocatalysis, it is advantageous, if the crystal size of titanium dioxide is small and its specific surface large. The limit between the UV region and the visible region is 400 nm. The visible region is from 400 to 700 nm and the UV region is less than 400 nm. Fluorescent lamps also give some UV radiation. In catalytic terms, a small crystal is more active than a large crystal, because the size of the forbidden energy difference increases and smaller wavelengths are capable of activating the photocatalysis.

The smaller the crystal or particle size of titanium dioxide, the more transparent the imprint provided by the treatment. A suitable crystal size is about from 3 to 200 nm, preferably from 10 to 100 nm. Particles with a crystal size of 3 to 30 nm are also preferable, and those of 5 to 20 nm even more preferable. The crystal size of transparent TiO₂ is less than 30 nm and its absorption maximum is in the UV region.

The agglomerates, which there preferably are among the nanoparticles, have sizes such as 1 to 20 micrometers, typically from 2 to 15 micrometers. The amount of agglomerates formed by nanoparticles is preferably over 50%, typically from 50 to 100%, suitably from 50 to 80%.

The specific surface of the titanium dioxide crystals is preferably 20-300 m²/g, typically 30-200 m²/g. Specific surfaces of 50-150 m²/g and 100-250 m²/g are also advantageous.

The specific surfaces can be measured by the BET method using nitrogen adsorption; the crystal size can be measured by an X-ray diffraction method from the broadening of the reflective pattern from Scherrer's equation. The portion of agglomerates can be assessed by a SEM microscope.

One of the titanium dioxide particles that have advantageous particle sizes and specific surfaces for outdoor use, in particular, is the photocatalytic titanium dioxide in anatase form. Such a photocatalytically acting titanium dioxide in particle form can be prepared according to the description of the published Patent Application WO 03/082743.

If the composition is spread in powder form by means of water, dustless titanium dioxide is preferably selected as the nanocrystalline titanium dioxide. Those preferable for the invention include photocatalyst samples such as PA, PRN and ANX that can be obtained from Kemira Pigments Oy. The PA sample is anatase and its crystal size is about 8 nm and specific surface about 180 m²/g. The PRN sample is rutile and its crystal size is 12 nm and the specific surface about 100 m²/g. The crystal size of ANX is about 20 nm, the specific surface about 100 m²/g, and the particle size approximately 1.2 micrometers. These products have an advantageous pH value and are, therefore, also suitable for spreading by hand. If the titanium dioxide is used as an aqueous solution, one suitable TiO₂ is, for example, a commercially available Degussa P25 (Degussa-Hüls AG). The amount of rutile in P25 is 20% and that of anatase is 80%. In P25, the crystal size of anatase is about 20 nm and that of rutile about 14 nm, and the specific surface is about 54 m²/g. The particle size of P25 measured in water is approximately 1.2 micrometers. The device used for the measurement was Master Sizer MS 20 and the measurement is based on the laser diffraction method.

Nitrogen-doped titanium dioxide particles or those, which were surface-treated with additives, such as dispergents, did not function very well in the method according to the invention. The nitrogen-doped particles left a yellow colour, and at least some of the additives used as dispergents did not come completely off the fabrics in washing.

In some applications, instead of powder, preforms, tablets or the like can be used, if the composition is spread onto the desired surface by means of a water spray, for example, as in dishwashing machines. If the spreading is carried out by hand and by means of a cloth, powder is more advantageous and, in that case, the slightly abrasive effect of titanium dioxide can be better exploited.

As titanium dioxide functions as a photocatalyst on the surface being protected, it is preferred to catalyze the treated surfaces indoors by means of visible light and, outdoors, by natural light. Indoors, about from 1 to 3 days is enough for the photoactivation, generally, from 1 to 2 days. Outdoors, in the summer, from 2 to 12 hours is sufficient for the photoactivation, typically from 3 to 5 hours and, in the winter, from 1 to 5 days, typically from 2 to 3 days.

The composition comprising titanium dioxide can be spread onto the surface being treated by means of a cloth, some material that is generally used in cleaning, such as a chifonet® cloth, a sponge or some other auxiliary means. The cloth or the other means is dipped in water and some composition containing titanium dioxide is applied to the cloth or the other means. The surface to be treated is wiped until the surface is clearly white and until the composition has spread throughout the surface as evenly as possible. After this, the layer that has formed is thinned by rinsing with water until the lightness of the layer disappears. The disappearance of lightness from glass panes, mirrors and other surfaces can be observed, as the surface becomes transparent.

Outdoors, surfaces comprising titanium dioxide are preferably rinsed with water. Alternatively, excess titanium dioxide can be removed by wiping with a soft cloth or vacuuming the treated surface. Indoors, for example, dry wiping is preferable, as water cannot generally be handled indoors as easily as outdoors. It is most preferable to use distilled water in rinsing, so that no lime trails remain on the treated surface. However, when using normal water, the result is often good enough.

Painted walls, ceilings and other large surfaces can be treated, for example, so that a sufficiently thick, preferably a thixotropic mixture is prepared from the titanium dioxide by means of water. Such a mixture is then applied, for example, on a paint roller and spread onto the surface being treated by means of the roll.

Cloths can also be treated with the composition comprising titanium dioxide. In that case, a thixotropic mixture can be made from the composition by means of water, which mixture can be spread on a cloth by means of a spatula, for example. Any excess composition that contains titanium dioxide can be wiped, vacuumed or shaken.

Whether or not the excess titanium dioxide should be removed from the surface depends on the application and the way of spreading.

The composition comprising titanium dioxide preferably includes nanocrystalline titanium dioxide at least as much as is needed for preparing the thixotropic mixture. On the other hand, in principle, only enough water for spreading the mixture onto the surface is needed. The composition suitably contains over 32% by weight of nanocrystalline titanium dioxide, more suitably over 35% by weight, preferably from 40 to 100% by weight, more preferably from 42 to 100% by weight. The thixotropic mixture typically contains from 40 to 80% by weight, preferably from 42 to 70% by weight, most preferably from 42 to 60% by weight of titanium dioxide. The composition can also be used as a titanium dioxide powder of 100% by weight or some water can be included, whereby the spreading should be carried out with a moistened cloth, sponge or some other means.

The film that is formed on the treated surface from nanocrystalline titanium dioxide has preferably a thickness of 15 nm to 150 micrometers, more preferably from 15 nm to 100 micrometers, more preferably from 15 nm to 60 micrometers, more preferably from 1 micrometer to 10 micrometers, typically from 2 micrometers to 10 micrometers. In some applications, a film can be advantageous, which has a thickness of 15 nm to 100 nm. The thickness of the layer can be adjusted by rinsing the surface with a larger amount of water, by spraying or wiping with a dry cloth, sponge or other means. If very thick on a vertical surface, in particular, the layer may crack. A thinner layer stays better on the surface and, according to our observations, however, functions as a photocatalyst rendering the surface hydrophilic. Even a thicker layer of titanium dioxide stays on the surface, if the surface is rough (e.g., a brick surface). If the surface being treated is white or if the white colour of the titanium dioxide layer is otherwise to be exploited, a thicker layer can be left on the surface.

The thickness of the titanium dioxide layer defines the colour of a pearlescent pigment. Accordingly, the thin film that is formed during cleaning reflects colours in the same way as the film (of 15 nm) on the self-cleaning window according to prior art. The reflection on thin films is minimal. A TiO₂ film is formed from the particles, and the film provides a reflection depending on the angle, from which the surface is looked at.

The thixotropic composition that comprises titanium dioxide can be prepared by mixing nanocrystalline titanium dioxide and water, for example, in a weight ratio of 2:1. As described above, the composition can be thicker than this and titanium dioxide powder can be used as such when spread with a cloth or by some other means. The thixotropic, paint-like composition preferably contains titanium dioxide in proportion to water in an amount of at least 0.7, more preferably at least 0.74, most preferably at least 0.8. In terms of weight percentage, the mixture preferably contains at least 40% by weight, more preferably at least 43% by weight of titanium dioxide. Preparing a suitable paint-like mixture depends on the properties of the titanium dioxide and the application; hence, lower or higher dry contents are possible. The mixture can be prepared and used immediately or it can be kept in light at a low temperature for from at least a few days to one week. It is preferable to prevent the evaporation of water, or to replace the evaporated water with fresh water. If the composition is kept in dark, whereby the anti-microbial effect of the titanium dioxide does not function, a suitable amount of agents, such as ethanol, which prevent the growth of microbes, can be added to the composition to prevent the growth of microbes.

The thixotropic agents refer to substances, the viscosity of which decreases when mixed and slowly returns back to the original viscosity, when mixing is stopped.

The composition comprising titanium dioxide can include small amounts of other substances, such as alcohol, but these are not necessary for the functioning of the invention. The amount of alcohol can be from 0.1 to 30% by volume from the amount of water, preferably from 0.1 to 20% by volume. Suitable alcohols include isopropanol, ethanol or methanol, in particular.

The composition comprising titanium dioxide can also include non-ionic, anionic, amphoteric or cationic tensides or mixtures thereof. However, the tensides are not necessary for the composition. The amount of tensides in the compositions according to the present invention can be within a range of 0.1 to 25% by weight, preferably from 0.1 to 15% by weight.

The composition can also comprise one or more of the following substances: enzymes, bleaching agents, and agents suitable for the adjustment of pH, stabilizers, binding agents, odorants, fluorescent agents, colouring agents, antistatic and/or antimicrobial agents, preservatives, anti-mould agents, anti-foam agents and, in some cases, suitable dispergents.

As the composition utilizes the capability of titanium dioxide to bind itself to the surface, it is not necessary to add binding agents to the composition. Thus, the amount thereof is preferably less than 22% by weight, more preferably less than 15% by weight, and even more preferably less than 10% by weight.

The composition can also comprise hydrophilic agents other than titanium dioxide, such as barium sulphate or, e.g., hydrophilic inorganic oxides, such as tin oxide, zinc oxide, iron oxide, cerium oxide etc. The amount of these compounds in the composition is preferably less than 15% by weight, preferably less than 10% by weight, and more preferably less than 5% by weight.

As titanium dioxide itself is very hydrophilic, it is not necessary to add to the present composition agents that increase the hydrophilicity.

Filling agents, such as phosphonate, zeolite or corresponding agents can be added to the composition but it is not necessary to add them to the compositions according to the present invention.

It was observed that titanium dioxide powder ran in water nearly as well as when in powder form. Thus, the flowing property of the titanium dioxide powder is good. Although lying on the bottom while the aqueous slurry stands, the TiO₂ mixes forming a uniform dispersion when mixed or shaken. Thus it will not cake together on the bottom. In this respect, additives and a smooth dispersion are not necessary.

In compositions according to the preferable embodiments of the invention, the amount of titanium dioxide and water is at least 75% by weight, preferably at least 80% by weight, more preferably at least 85% by weight, even more preferably at least 90% by weight, further more preferably at least 95% by weight, and most preferably at least 98% by weight. Consequently, the portion of the other ingredients is preferably less than 25% by weight, more preferably less than 20% by weight, even more preferably less than 15% by weight, further more preferably less than 10% by weight, even more preferably less than 5% by weight, and most preferably less than 2% by weight. The preferred compositions according to the invention essentially contain nanocrystalline titanium dioxide and water only and small amounts of other substances, at the most. The surface that is formed by the method according to the invention contains titanium dioxide as its main component. The surface preferably contains at least 85% by weight, more preferably at least 90% by weight, even more preferably at least 95% by weight, and most preferably at least 98% by weight of titanium dioxide.

A surface that has been rendered hydrophilic can be wiped with water and a soft cloth, when necessary. However, abrasion and scratching of the treated surface should be avoided. As a new treatment does not require laborious removal of a previous treatment and/or grinding, the surface treatment is easy to renew. When necessary, the surface can also always be patched by adding TiO₂ to places where it has disappeared from.

It is preferable to use the titanium dioxide composition to treat glass surfaces, such as glass panes and mirror surfaces, in particular. It is preferable to treat, for example, the windows, the side view mirror and the rear window of a car. Because of increased reflections, it is not preferable to apply the titanium dioxide film on the windscreen. An extra advantage in treating the car's side view mirror is brought about by the fact that the surface will not fog up as heavily in cold weather as an untreated mirror surface would. Treated side windows of the car, in turn, melt considerably quicker than untreated side windows.

Eye glasses, including plastic ones, can also be treated with the composition according to the invention. The titanium dioxide composition forms a layer on the surface of the eye glasses, decreasing their fogging up when the temperature changes quickly, as in a sauna, for example.

The composition according to the invention can be used to treat plastic surfaces, such as range hoods, ceramic or glass ceramic tiles, such as the tiles of bathrooms and kitchens, metal surfaces, such as the metal surfaces of dishwashing machines and baking ovens, and painted walls and ceilings. The compositions according to the invention can also be used to treat road signs, whereby the signs need not to be washed as often as earlier.

As titanium dioxide is capable of removing harmful formaldehyde evaporating from surfaces, there has been a tendency in prior art solutions to add titanium dioxide to inorganic paints in particular. When mixed with paint, titanium dioxide does not necessarily remain on the painted surface but, instead, inside the paint where it is not in contact with air. In the method according to the present invention, the painted surface is treated with a composition containing titanium dioxide and, in that case, the surface is in contact with air.

Although some of it may come off the treated surface when wiped, or it may stick to one's clothes, for example, when leaning against a wall, the titanium dioxide can be removed by washing, and the titanium dioxide is not toxic or detrimental to the environment.

In solutions according to prior art (WO 99/51345), photocatalysts have been bound to different surfaces by means of silicon-based compounds. In the present invention, it has been observed that binding titanium dioxide to a cloth is not necessary, but a layer of titanium dioxide can be spread onto the cloth as a paint-like aqueous solution by means of a spatula, for example. Any extra layer of titanium dioxide can be removed by wiping or lightly shaking.

Generally, the compositions according to the invention can be used for treating surfaces of various materials, such as glass, ceramics, white goods, stainless steel, copper, brass, tin, chrome, nickel, aluminium, enamel, plastics, acrylics, treated wood (e.g., lacquered, painted, oiled), marble, brick, potstone, fibreglass, cast marble, enamelled steel plate, painted steel plate, different cloths.

The compositions according to the invention can be used to treat various non-living surfaces, which are exposed to oxygen and natural light or artificial light.

The composition according to the invention can also be used for treating the following surfaces, for example: dishes, kitchen sinks and bowls, taps, kitchen cabinets, refrigerators, stoves, ceramic glass surface cooking levels, ovens, baking trays, microwave ovens, grills, bathroom fixtures, tiles, clinkers, windows, shutters, acoustic panels, room separator walls, furniture. ornaments, jewellery, prize trophies, curtains, tapestries etc.

The composition is also well-suited for cleaning, for example, bicycles, motorcycles, cars, traffic signs, caravans, boats, garden furniture, jogging shoes, skis, etc.

The composition according to the invention is especially well-suited for treating various surfaces of public facilities, such as schools, day care centres, offices, hospitals, restaurants, hotels, shops, etc.

### EXAMPLES

### Example 1

Dirty light-coloured tiles were washed with commercial detergents: liquid Pirkka scouring liquid, VIM Cream original, Sampo powder, Degussan P25, the FINNTi S 140 of Kemira Pigments Oy, ANX type A, and a photocatalyst sample PA. All washing and cleaning agents made the tiles clean. In cleaning, chifonet® cloths were used. The liquid agents had irritating odours and they dribbled. Sampo spread well and washed well, but the powder in the jar caked together with use. Finnti S140 did not spread well but cleaned well as a result of heavy scouring. ANX spread well and cleaned well but had the disadvantage of making a white coating. At first, P25 did not moisten very well but, finally, gave a fairly good washing result. P25 exhibited some white covering. Spreading very well onto the surface and washing well, the photocatalytic anatase PA was pleasant to use. The clean white colour and the softness of the photocatalytic anatase powder made the cleaning pleasant.

### Example 2

The effectiveness of the photocatalytic anatase sample PA in cleaning was tested by spreading the sample in powder form onto the following surfaces by means of a cloth moistened in water: a cooking level, light tiles, dark blue tiles, the surfaces and the door of a refrigerator and a cooler, copper doorknobs, the surfaces and doors of cupboards, kitchen chairs, a shower cubicle, a kitchen worktop, painted walls, the surfaces of a dishwasher, plates with adhered food, the shower cubicle from the inside and outside, wash basins and a fish bowl. Scouring was needed only for detaching dirt that had adhered tightly. When assessing the results on a scale of 1 to 5 (1=the worst result, 5=the best result), the cleaning result was in the order of 4 to 5, except for the cases, where dirt had been embedded extremely tightly. In that case, it was necessary to scour harder. The cleaning result was in the order of 2 to 4.

### Example 3

A light-coloured piece of table linen had been soiled by soot from candles. The piece was washed with a PRN powder sample. A towel was moistened with water and then dipped in the powder. The spot was rubbed with the towel and, as a result of the treatment; the dark colour caused by the candle came off the piece of linen.

### Example 4

A paste was prepared from the photocatalytic anatase sample PA, containing:

| | | |
|---|---|---|
| I | 20 g of titanium dioxide | 10 ml of water (67% by weight) |
| II | 20 g of titanium dioxide | 25 ml of water (44% by weight) |
| III | 20 g of titanium dioxide | 27 ml of water (43% by weight) |
| IV | 20 g of titanium dioxide | more than 27 ml of water (under |
| | | 43% by weight) |
| V | 5 g of titanium dioxide | 4 ml of water (55% by weight) |

It was discovered that the mixtures from I to III formed a thixotropic mixture, whereas the mixture IV no longer formed a thixotropic mixture.

### Example 5

The thixotropic mixtures prepared in Example 4 were spread onto a painted wall by means of a spatula. Any excess composition was removed by wiping with a soft cloth. A thin layer of titanium dioxide remained on the wall. When brushing the wall by hand, a white surface stuck to the hand but, otherwise, the layer remained on the wall well. After one year from the treatment, the titanium dioxide surface was still intact. When part of the titanium dioxide surface was wiped off, the paint surface under the surface was as before.

### Example 6

The thixotropic mixtures prepared in Example 4 were spread onto the surface of curtains by means of a spatula. The curtains were aired heavily; however, a thin layer of titanium dioxide remained on the surface of the curtains. When washed with a large amount of water, the titanium dioxide came off the curtains.

### Example 7

The thixotropic mixtures prepared in Example 4 were spread onto the surface of a canvas. The layer was thinned by vacuuming the dried layer of titanium dioxide. After vacuuming, a thin layer of titanium dioxide remained on the surface of the canvas.

### Example 8

The thixotropic mixtures prepared in Example 4 were spread onto the surface of the filter cloth of an air cleaner. Any excess titanium dioxide was detached by gently shaking. After this, a thin layer of titanium dioxide remained on the surface.

### Example 9

The thixotropic mixtures prepared in Example 4 were spread onto the outer surface of a window. Any excess titanium dioxide was removed with a light water spray. After this, a thin layer of titanium dioxide remained on the surface. The layer remained on the surface of the glass throughout the year with the temperature ranging from about −30° C. to +30° C., still functioning hydrophilically.

### REFERENCES

Fujishima, A. K Hashimoto, T. Watanabe: TiO₂ photocatalysis. Fundamentals and Applications (BKC, Inc., Tokyo Japan 1999). Shirthikeyan, M.: Nanostructured Mater. Vol. 5, (1995), p. 33.

Ha, H., Nam, S., Lim, T., Oh, I. Hong, S.: Journal of Membrane Science Vol. 111 (1997), p. 82.

Hocken, J. and Proft, B. Clean surfaces by utilization of the photocatalytic effect. www.Sachtleben.de/publications (2003).

Perry, F., Billard, A., Frantz, C.: Surface Coating Technology Vol. 94 (1997), p. 681.

Sugail, M. H, Rao, G. M. and Mohan, S.: J. Appl. Phys. Vol. 71 (1992), p. 1421.

Jang, M., Kim, S. K., Oh, H. J., Lee, J. H., Chi, C. S.: Korea Journal of Materials Research Vol. 11 (2001), p. 61.

Zhu, Y., Huang, M., Huang, J. and Ding, C.: J. Therm. Spray Technol. Vol. 8 (1998), p. 219.

1. A method for treating a surface with titanium dioxide, characterized in that
the surface is treated with a composition that comprises nanocrystalline titanium dioxide, and
the composition is used as a powder or aqueous solution, wherein the dry content of the titanium dioxide is as high as or higher than a concentration, wherein the solution becomes thixotropic and wherein the power of the titanium dioxide to bind itself to the surface is exploited,
whereby, when spread onto the surface by means of water, the composition remains on the surface even after physical removal, forming a photocatalytic and/or dirt repellent layer on top of the treated surface.

2. A method according to claim 1, characterized in that the titanium dioxide in the composition is in the form of particles, an essential part of which are capable of sedimenting in the water.

3. A method according to claim 1 or 2, characterized in that over 50% of the titanium dioxide crystals in the composition is in the form of agglomerates.

4. A method according to claim 1, characterized in that the crystal size of the titanium dioxide in the composition is from 3 to 200 nm.

5. A method according to claim 1, characterized in that the specific surface of the titanium dioxide is from 20 to 300 m²/g.

6. A method according to claim 1, characterized in that the composition contains at least 42% by weight of nanocrystalline titanium dioxide.

7. A method according to claim 1, characterized in that the amount of nanocrystalline titanium dioxide and water in the composition totals in over 75% by weight.

8. A method according to claim 1, characterized in that the composition contains one or more of the following: barium sulphate, hydrophilic inorganic oxides, such as tin oxide, zinc oxide, iron oxide.

9. A method according to claim 1, characterized in that the surface being treated is a non-living surface that is exposed to oxygen and natural light or artificial light.

10. The use of nanocrystalline titanium dioxide as powder or thixotropic aqueous solution for treating surfaces by exploiting the power of the titanium dioxide to bind itself to the surface.
